(19) United States
(12) Patent Application Publication
(10) Pub. No.: US 2023/0064649 A1
(43) Pub. Date: Mar. 2, 2023

(54) INSULATED SPECIMEN CONTAINER

(71) Applicant: Otter Products, LLC, Fort Collins, CO (US)

(72) Inventors: CHRISTOPHER J. MELANSON, Fort Collins, CO (US); TODD EICHINGER, Fort Collins, CO (US); FENG S. LIU, San Diego, CA (US); MATTHEW A. RYAN, Fort Collins, CO (US)

(21) Appl. No.: 17/883,079

(22) Filed: Aug. 8, 2022

Related U.S. Application Data
(60) Provisional application No. 63/236,792, filed on Aug. 25, 2021.

(51) Int. Cl. B65D 81/38; B65D 55/16; B65D 55/02; B65D 25/06; F25D 3/08; B65D 21/02

(52) U.S. Cl. CPC B65D 81/3818; B65D 55/16; B65D 55/02; B65D 25/06; F25D 3/08; B65D 21/0212; B65D 2555/02

(57) ABSTRACT

An insulated shipping container system for transporting temperature sensitive specimens includes an insulated body, an insulated lid, and a stretchable strap. The insulated body has an internal cavity that is accessible through an opening and has a cross-sectional shape. The insulated lid is configured for selectively closing the opening to the internal cavity when the lid is in a closed position. The stretchable strap is removably attachable to each of the insulated body and the insulated lid. The stretchable strap is configured to stretch and attach to a lug on the insulated body to selectively hold the insulated lid in the closed position and further configured to retain the insulated lid to the insulated body when the lid is in an opened position. The insulated shipping container system may also include a freezable cold pack having a shape corresponding to the cross-sectional shape of the internal cavity.

### CROSS REFERENCE TO RELATED APPLICATIONS

This application claims priority to U.S. Provisional Patent Application No. 63/236,792, filed Aug. 25, 2021, which is hereby incorporated by reference in its entirety.

### FIELD

This disclosure relates generally to portable insulated containers for objects, such as shipping containers for medical or scientific items.

### BACKGROUND

It is often desirable to ship or store medical supplies, samples, specimens, scientific samples, and/or other items while keeping them within a specified or predetermined temperature range. Exposure, particularly to temperatures outside the predetermined temperature range, may render the items damaged or unusable. It may also be desirable to provide some degree of physical protection to the items being shipped.

Currently available shipping containers may suffer from one or more disadvantages, such as requiring large volumes of ice or other coolant(s) to maintain the temperature of the items within the predetermined range. Even during more moderate environmental temperatures, some items may not be shipped if the expected delivery time exceeds the capacity of the shipping container to maintain the predetermined temperature range. Medical items and specimens can be particularly sensitive to temperature changes. Lower quality or inexpensive containers often require more ice to ensure that the items are kept cool during the entire shipping process.

It is therefore desirable to be able to ship these types of items in a container providing improved temperature protection with a higher degree of insulation and protection to better maintain the temperature within the chamber within a predetermined temperature range.

### SUMMARY

Insulated shipping containers are used for a variety of purposes and in conjunction with a variety of activities. A container may be insulated to assist in keeping one or more items cool, cold, frozen, warm, or hot. The container may also be used to protect one or more items from damage, bumps, impact, light, and/or contaminants. While most of the examples discussed herein are discussed with respect to a container for keeping the contents cool, it should be understood that the techniques and features disclosed herein are applicable to other types of shipping, storage, or temperature control containers, including containers for keeping items warm or hot. The containers disclosed herein may have multiple components and may be configured in the form of a system or kit. The containers disclosed herein may be configured to be carried or transported in a plurality of manners or configurations.

In one example, an insulated shipping container system for transporting temperature sensitive specimens includes an insulated body, an insulated lid, and a stretchable strap. The insulated body has an internal cavity that is accessible through an opening or aperture and has a cross-sectional shape. The insulated lid is configured for selectively closing the opening to the internal cavity when the lid is in a closed position. The stretchable strap is removably attachable to each of the insulated body and the insulated lid. The stretchable strap is configured to stretch and attach to a lug on the insulated body to selectively hold the insulated lid in the closed position and further configured to retain the insulated lid to the insulated body when the lid is in an opened position. The insulated shipping container system may also include a freezable cold pack having a shape corresponding to the cross-sectional shape of the internal cavity. The insulated shipping container system may also optionally include a shipping case configured to cover the insulated body and the insulated lid when the insulated lid is in the closed position. The insulated shipping container system may also optionally include a spacer for reducing movement of items inside the container.

Other variations and embodiments are possible, including variations and embodiments which do not necessarily include all of the elements described above and/or variations and embodiments which may include additional elements.

### BRIEF DESCRIPTION OF THE DRAWINGS

FIG. 1A illustrates an example of a shipping container;

FIG. 1B illustrates another example of a shipping container;

FIG. 2 illustrates the shipping container of FIG. 1A disassembled;

FIG. 3A illustrates a specimen tray in a closed position;

FIG. 3B illustrates the specimen tray of FIG. 3A in an opened position;

FIG. 4A illustrates a specimen tray in a closed position;

FIG. 4B illustrates multiple stacked specimen trays;

FIG. 5 illustrates the shipping container of FIG. 2, some of the specimen trays of FIGS. 3A-4B, and an ice pack;

FIG. 6A illustrates the shipping container of FIG. 1A and a shipping case or sleeve for use with the shipping container;

FIG. 6B illustrates the shipping case of FIG. 6A in an opened position;

FIG. 7A illustrates a portion of the shipping container of FIG. 2 with an inner support;

FIG. 7B illustrates the inner support of FIG. 7A;

FIG. 8 illustrates a portion of the shipping container of FIG. 2 with a different inner support than FIG. 7A; and

FIG. 9 illustrates a portion of a shipping container also including a reinforcing ring.

### DETAILED DESCRIPTION

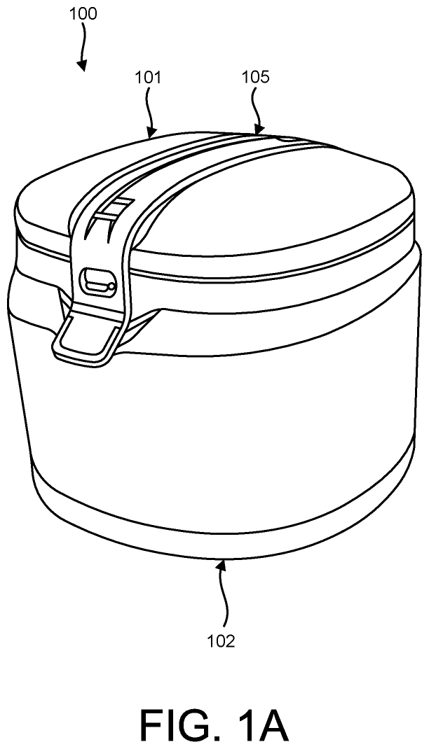

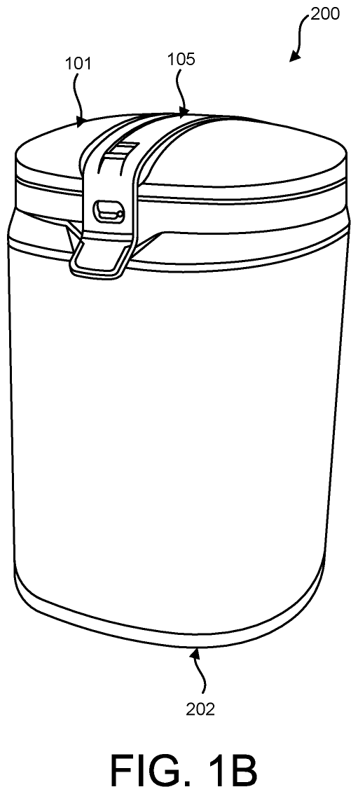

FIG. 1A illustrates exemplary shipping container 100. Shipping container 100 includes an insulated body 102 and an insulated lid 101. Insulated body 102 includes a bottom surface and a plurality of walls which define an internal cavity or storage space. In other embodiments, insulated body 102 and/or insulated lid 101 may have another suitable shape, such as rectangular, round, or hexagonal.

The walls of insulated body 102 and/or insulated lid 101 include one or more forms of insulation for maintaining a preferred temperature or temperature range during shipping. In one specific example, insulated body 102 and/or insulated lid 101 may include inner and outer walls which are separated by an internal space between the walls which is evacuated to create a vacuum insulated wall structure. Vacuum insulated walls can provide high performance insulation characteristics. In some examples, body 102 and/or insulated lid 101 may be constructed of a metallic material, such as stainless steel. Shipping container 100 also includes removably strap 105.

FIG. 1B illustrates a shipping container 200 which has similarities to shipping container 100 of FIG. 1A, but has an insulated body 202 that is taller than insulated body 102 such that shipping container 200 has a larger internal storage cavity or volume while still being compatible with the same insulated lid 101. Both shipping container 100 and shipping container 200 use removable strap 105 for selectively holding insulated lid 101 in a closed position.

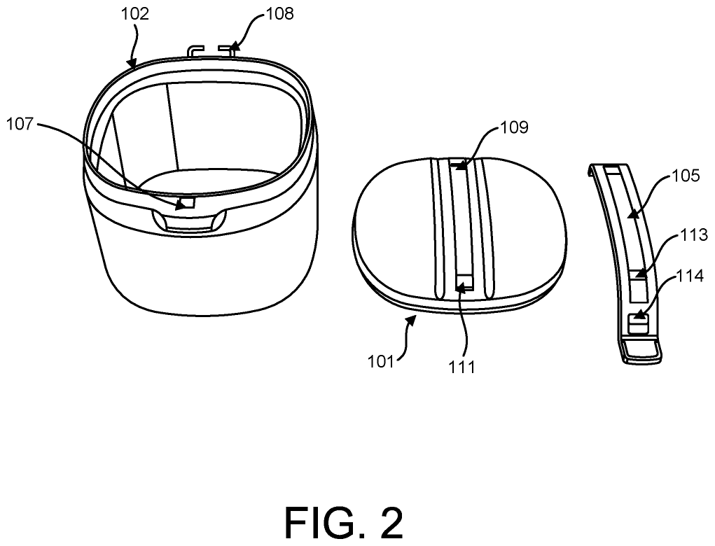

FIG. 2 illustrates shipping container 100 of FIG. 1A in a disassembled configuration. Strap 105 and insulated lid 101 may each be removable from insulated body 102 for purposes of cleaning, stacking, replacement, and/or interchange with other components. Insulated body 102 includes hinge pins 108, or a similar mechanical attachment structure, for removably attaching strap 105 to insulated body 102 such that strap 105 can pivot relative to insulated body 102 as well as be easily removed. One or more gaskets, seals, tamper resistant features, tamper evident seals, or tamper proof seals may be used between insulated lid 101 and insulated body 102.

Strap 105 includes one or more attachment features, such as aperture 113, configured to engage with one or more attachment features of insulated lid 101, such as cleat 109 and/or cleat 111, for removably attaching strap 105 to insulated lid 101. Strap 105 also includes one or more attachment features, such as aperture 114, configured to engage with one or more attachment features of insulated body 102, such as lug 107. When strap 105 is removably attached to insulated lid 101 and insulated body 102 it can be used to temporarily hold insulated lid 101 in the closed position illustrated in FIG. 1. Strap 105 may need to be stretched to engage aperture 114 with lug 107 such that specific and/or intentional force is needed to open shipping container 100. In addition, insulated lid 101 remains attached to strap 105, and indirectly to insulated body 102, when insulated lid 101 is pivoted back into an open position.

The insulated shipping containers or shipping container kits or systems disclosed herein may be used for storing or shipping any item or items that must be controlled or kept within particular temperature ranges. In some examples, one or more medical items, materials, scientific samples, or specimens may be stored or stored or shipped in one of the of insulated shipping containers or shipping container kits or systems disclosed herein.

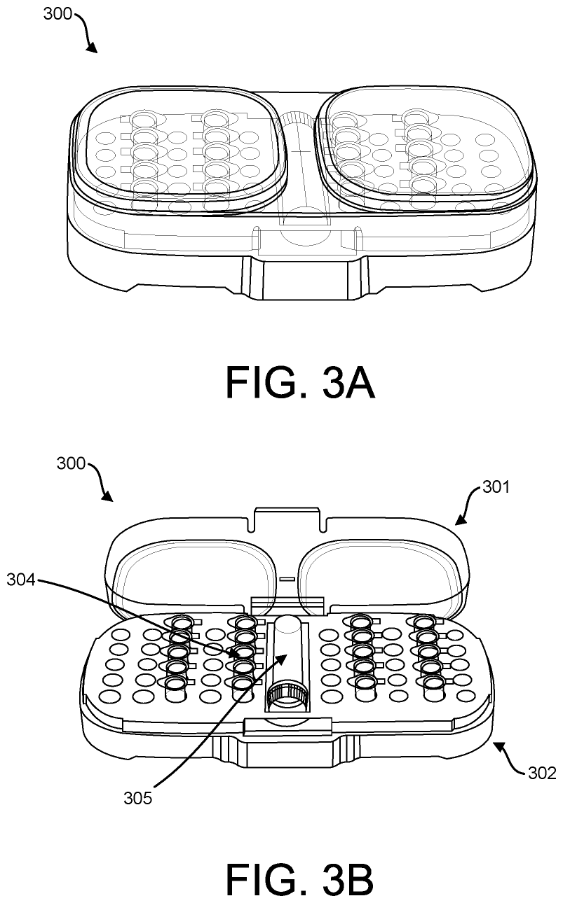

FIG. 3A illustrates one example of a specimen tray 300 which may be used with any of the shipping containers disclosed herein. Specimen tray 300 may be sized to correspond to and fit in a cross sectional shape of the internal cavity of any of the shipping containers disclosed herein to reduce movement of specimen tray 300 in the cavity. In another example, specimen tray 300 may be sized such that multiple instances of specimen tray 300 sitting side by side correspond to and/or fit in a cross sectional shape of the internal cavity of any of the shipping containers disclosed herein to reduce movement of specimen trays 300 in the cavity. For example, two instances of specimen tray 300 may be placed side by side to fit a roughly square cross sectional area of an internal cavity of any of the containers disclosed herein.

FIG. 3B illustrates specimen tray 300 with lid 301 opened from base 302. Specimen tray 300 is capable of holding a plurality of specimen containers 304. In one specific example, specimen tray 300 may be configured for holding a plurality of polymerase chain reaction (PCR) tubes. Many other configurations are possible. Specimen tray 300 may also include another storage area, such as storage area 305. In one specific example, storage area 305 may be configured for holding a buffer tube. Many other configurations are possible.

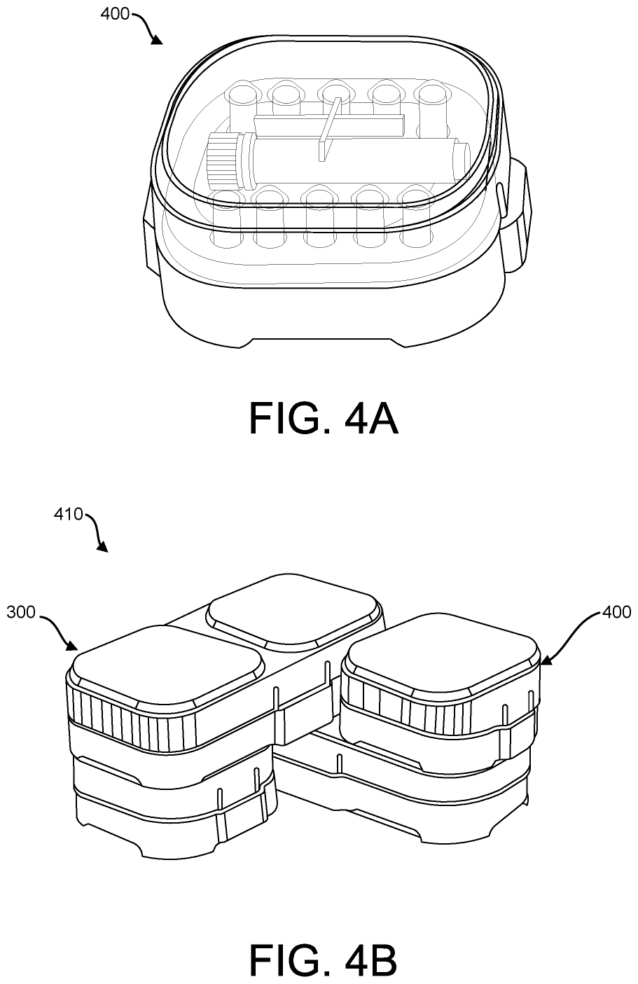

FIG. 4A illustrates another specimen tray have a different size than specimen tray 300 of FIGS. 3A and 3B. FIG. 4B illustrates a specimen tray group 410 which are stacked on each other. Specimen tray group 410 may include a combination of specimen trays of different sizes, such as specimen tray 300 and specimen tray 400, such that a variety of trays can be combined or stacked to fit in a shipping container.

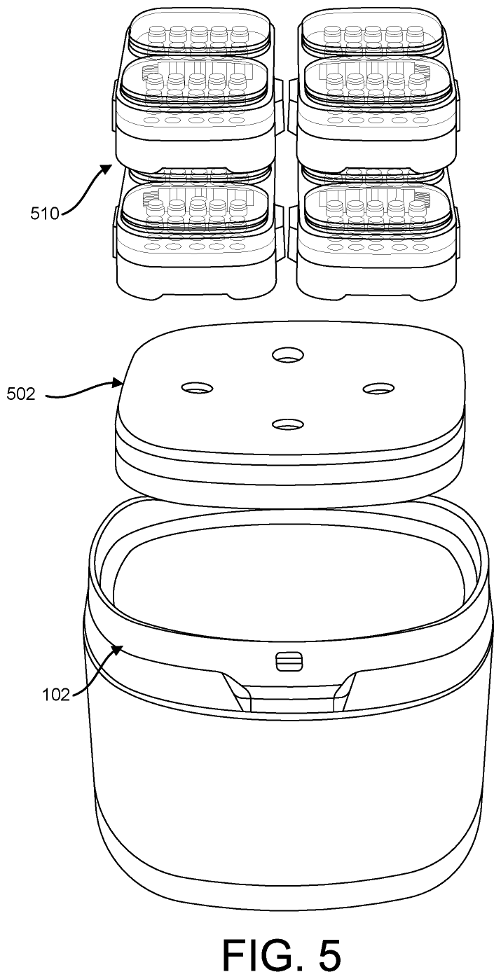

FIG. 5 illustrates another specimen tray group 510 configured to be inserted into the storage cavity of insulated body 102, possibly on top of a cold pack 502. Cold pack 502 may be or may include any type of thermal mass, ice pack, freeze pack, cold pack, and/or phase change material. Cold pack 502 may also be sized and/or shaped to fit the internal cavity of insulated body 102. Cold packs with different sizes, thicknesses, and/or thermal capacities may be used. After insertion of cold pack 502 and specimen tray group 510, insulated lid 101 (not visible in FIG. 5) is closed on insulated body 102 and secured with strap 105.

In some examples, the shipping container kit or system may include one or more spacers of various sizes. The spacer(s) may be configured to occupy any remaining space in the internal cavity after one or more specimen trays have been inserted. The spacers may be shaped to fit the internal cavity of the shipping container similar to cold pack 502. The spacers may take up remaining space and reduce or eliminate movement of the specimen trays during shipping and/or provide additional insulation.

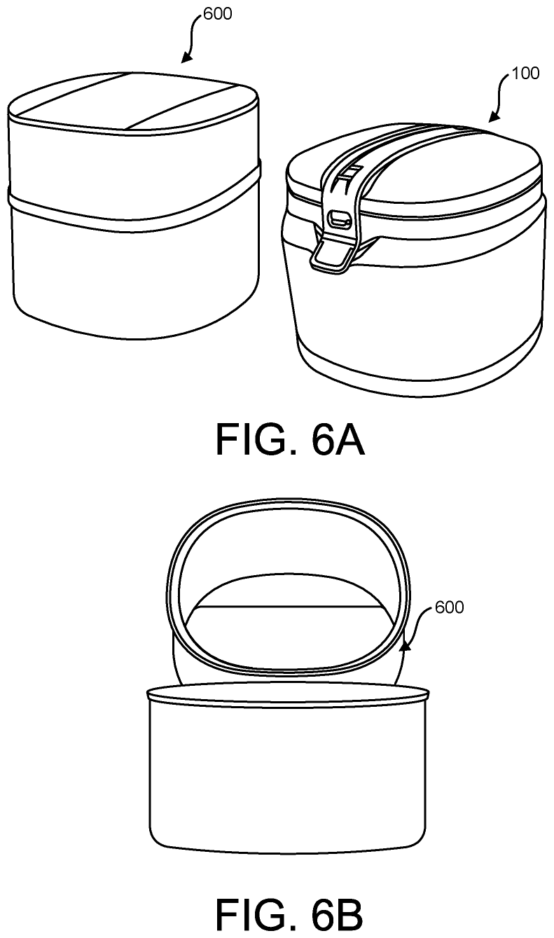

FIG. 6A illustrates shipping container 100 and a corresponding shipping case 600 into which shipping container 100 fits. Shipping case 600 may also be referred to as a shipping sleeve. Shipping case 600 may provide some additional protection, security, and/or insulation for shipping container 100. Shipping case 600 may be made from a material which provides some cushioning, padding, and/or impact resistance to shipping container 100. Shipping case 600 may include a window or pocket for receiving a shipping label. FIG. 6B illustrates shipping case 600 in an opened position.

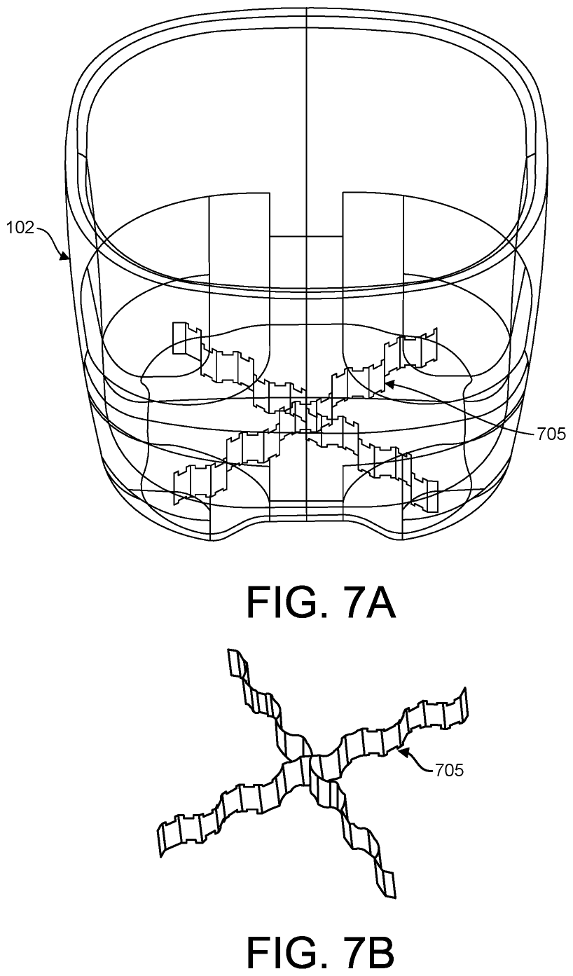

FIG. 7 illustrates a transparent view of insulated body 102 with an inner support 705. Some support may be required between the inner and outer walls of insulated body 102 to prevent them from bending or collapsing toward each other. This may be particularly true in the case of vacuum insulated instances of insulated body 102. Inner support 705 may exist between the inner and outer walls and contacts them at various locations to help maintain a distance between the inner and outer walls despite the vacuum, and potentially other forces, pushing or pulling them toward each other. Inner support 705 may be of any size, shape, structure, and/or material and may contact the walls in only a limited number of small areas to reduce any negative effects of the insulation properties. A support such as inner support 705 may be present in one or more locations other than that illustrated in FIG. 7A, as well as in insulated lid 101. FIG. 7B illustrates inner support 705.

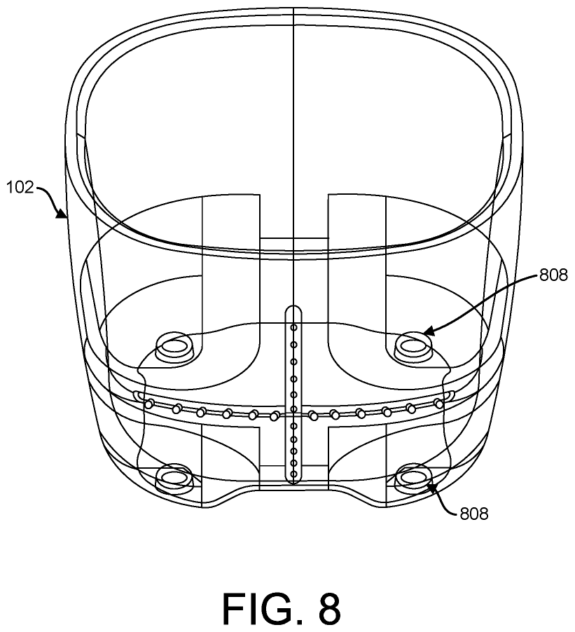

FIG. 8 illustrates an alternate transparent view of insulated body 102 with spacers 808 positioned between the inner and outer walls. Spacers 808 perform a function similar to that of internal support 705 and for similar purposes. Spacers 808 may be used in place of, or in conjunction with, a support such as inner support 705. Other configurations are possible.

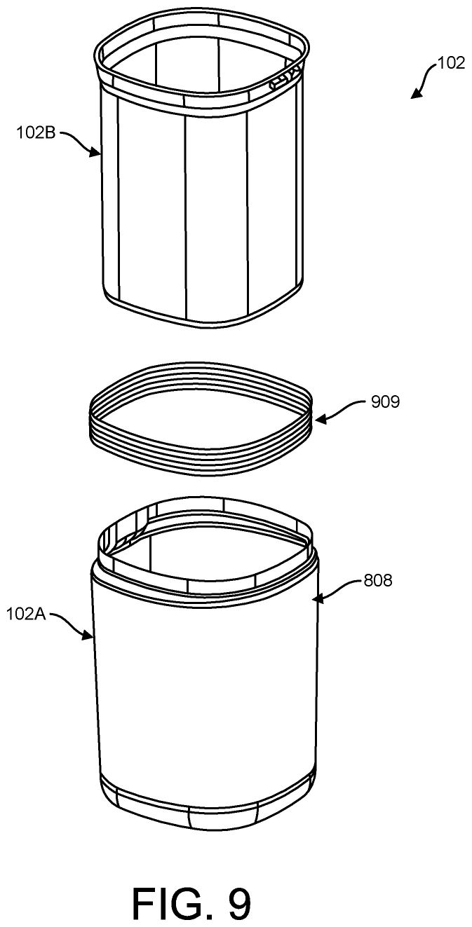

FIG. 9 illustrates an expanded view of components of insulated body 102 which includes a split band 909. Insulated body 102 may be constructed of an interior portion 102B which fits inside outer portion 102A and an insulating cavity is formed between the walls of inner portion 102B and the walls of outer portion 102A. Split band 909 is positioned between the inner walls and the outer walls and maintains spacing between the inner and outer walls. Split band 909 may also provide structural rigidity.

Any of the techniques, improvements, features, functions, or processes described herein may be implemented in the form of a system or a kit. The system or kit may include any combination of the devices, components, elements, and/or modules disclosed herein.

The techniques, elements, components, methods, and steps described herein are meant to exemplify some types of possibilities. In no way should the aforementioned examples limit the scope of the invention, as they are only exemplary embodiments.

The phrases “in some embodiments,” “according to some embodiments,” “in the embodiments shown,” “in other embodiments,” “in some examples,” “on other examples,” “in some cases,” “in some situations,” “in one configuration,” “in another configuration,” and the like generally mean that the particular technique, feature, structure, or characteristic following the phrase is included in at least one embodiment of the present invention and/or may be included in more than one embodiment of the present invention. In addition, such phrases do not necessarily refer to the same embodiments or to different embodiments.

The foregoing disclosure is presented for purposes of illustration and description. Other modifications and variations may be possible in view of the above teachings. The embodiments described in the foregoing disclosure were chosen to explain the principles of the concept and its practical application to enable others skilled in the art to best utilize the invention. It is intended that the claims be construed to include other alternative embodiments of the invention except as limited by the prior art.

What is claimed is:

1. An insulated shipping container system for transporting temperature sensitive specimens, the insulated shipping container system comprising:
an insulated body having an internal cavity accessible through an opening, wherein the internal cavity has a cross-sectional shape;
an insulated lid configured for selectively closing the opening to the internal cavity of the insulated body when the lid is in a closed position;
a stretchable strap that is removably attachable to each of the insulated body and the insulated lid, wherein the stretchable strap is configured to stretch and attach to a lug on the insulated body to selectively hold the insulated lid in the closed position, and further configured to retain the insulated lid to the insulated body when the lid is in an opened position;
a freezable cold pack having a shape corresponding to the cross-sectional shape of the internal cavity; and
a protective shipping case configured to cover the insulated body and the insulated lid when the insulated lid is in the closed position.

2. The insulated shipping container system of claim 1 further comprising a plurality of specimen trays each having a shape corresponding to the cross-sectional shape of the internal cavity.

3. The insulated shipping container system of claim 1 wherein the insulated body includes outer walls and inner walls separated by a vacuum insulated interior.

4. The insulated shipping container system of claim 3 further including a spacer between the inner walls and the outer walls.

5. The insulated shipping container system of claim 1 wherein the insulated lid has a vacuum insulated interior.

6. The insulated shipping container system of claim 1 wherein the stretchable strap is removably and hingedly attached to the insulated body.

7. The insulated shipping container system of claim 6 wherein the stretchable strap is hingedly attached to the insulated body on a side of the insulated body opposite the lug.

8. The insulated shipping container system of claim 1 further comprising a second insulated body to which the insulated lid and the stretchable strap may be attached, wherein the second insulated body is smaller than the insulated body.

9. The insulated shipping container system of claim 2 wherein the plurality of specimen trays includes specimen trays of two or more different sizes.

10. The insulated shipping container system of claim 2 further comprising a spacer for occupying an unused space in the insulated body.

11. A vacuum insulated shipping container for transporting temperature sensitive specimens, the insulated shipping container comprising:
a vacuum insulated body having an internal cavity accessible through an opening, wherein the internal cavity has a cross-sectional shape;
a vacuum insulated lid adapted for selectively closing the opening to the internal cavity of the vacuum insulated body when the lid is in a closed position;
a strap that is removably attachable to each of the vacuum insulated body and the vacuum insulated lid, wherein the strap is adapted to attach to a lug on the vacuum insulated body to selectively hold the vacuum insulated lid in the closed position, and further adapted to retain the vacuum insulated lid to the vacuum insulated body when the lid is in an opened position;
a freezable ice pack having a shape corresponding to the cross-sectional shape of the internal cavity; and
a cushioned shipping cover adapted to cover the vacuum insulated body and the vacuum insulated lid when the vacuum insulated lid is in the closed position.

12. The vacuum insulated shipping container of claim 11 wherein the vacuum insulated body includes outer walls and inner walls including one or more spacers between the inner walls and the outer walls.

13. The vacuum insulated shipping container of claim 11 further including a band which joins the vacuum insulated body and the vacuum insulated lid near the opening.

14. The vacuum insulated shipping container of claim 11 wherein the strap is stretchable strap and is removably and hingedly attached to the vacuum insulated body.

15. The vacuum insulated shipping container of claim 14 wherein the stretchable strap is hingedly attached to the vacuum insulated body on a side of the vacuum insulated body opposite the lug.

16. The vacuum insulated shipping container of claim 11 further comprising a second vacuum insulated body to which the vacuum insulated lid and the stretchable strap may be attached, wherein the second vacuum insulated body is smaller than the vacuum insulated body.

17. The vacuum insulated shipping container of claim 11 further comprising a spacer for occupying an unused space in the vacuum insulated body.

18. The vacuum insulated shipping container of claim 11 further comprising a plurality of specimen trays each having a shape corresponding to the cross-sectional shape of the internal cavity.

19. The vacuum insulated shipping container of claim 18 wherein the plurality of specimen trays includes specimen trays of two or more different sizes.

20. The vacuum insulated shipping container of claim 18 wherein the plurality of specimen trays are stackable on each other.
